(19) United States
(12) Patent Application Publication
(10) Pub. No.: US 2003/0121161 A1
(43) Pub. Date: Jul. 3, 2003

(54) Electric powered jigsaw with extension handle

(76) Inventor: Edgar Leon Swift, Roswell, GA (US)

Correspondence Address: EDGAR L. SWIFT, 1596 SANDPOINT DRIVE, ROSWELL, GA, 30075, US

(21) Appl. No.: 10/039,694

(22) Filed: Jan. 2, 2002

(51) Int. Cl. B23D 49/04

(52) U.S. Cl. 30/392

(57) ABSTRACT

An improved electrically powered lightweight jigsaw attached to an extension handle that allows a user to perform cutting tasks at a distance far beyond the user's normal reach. It features a double-edged blade that allows a user to cut a workpiece by either pushing the saw into it, or pulling the saw into or across it without having to remove the blade to change the orientation of its teeth. The saw is capable of cutting a workpiece nearly flush with a raised surface, such as a wall or tree trunk, lying in an intersecting perpendicular plane. It can be manufactured by making minimal modifications to a typical conventional hand-held jigsaw, and could be sold through a manufacturer's established distribution channels, using its existing personnel, with minimal training.

### BACKGROUND

1. Field of the Invention

This invention relates to jigsaw based electric powered cutting devices that are attached to a long handle, either of fixed length or variable length, that enable a user to perform cutting tasks at a distance far beyond the user's normal reach. Since jigsaws are also often referred to as saber saws, sabre saws or scroll saws, I will use the terminology “jigsaw” to refer to all such devices throughout this patent application. The jigsaws referred to in this application are particularity those that have a handle for one-hand use and control of the saw, a housing, an electric motor within the housing and a mechanism, also contained within the housing, for converting the radial motion output of the motor to linear motion at a blade actuator that reciprocates a cutting blade in a plane perpendicular to the plane of the longitudinal centerline of the saw's housing.

2. Description of Prior Art

There is at least one documented attempt to use a jigsaw for the purpose stated in the field of this invention. There are other inventions proposing the use of other types of electric powered cutting tools attached to long extension handles known in the prior art as well. I shall address three such inventions in this patent application in an attempt to provide a framework in which the value of the present invention can be best understood and appreciated.

One invention using an extension handle equipped jigsaw as the base for a tree pruning device is described in U.S. Pat. No. 4,566,188 to Wilson issued Jan. 28, 1986. It uses an elongated handle which enables the user to raise the saw to the branch that is to be trimmed and then suspend the device from that branch by hooking an attached open-mouthed, angled bracket over the branch. The user then turns loose the rigid handle of the device and holds on to it only by its power cord and switch. The user then moves far enough from the tree to be out of the way when the branch is severed and falls, then turns on the power switch, relying on the angled bracket to hold the saw in place while the branch is being cut.

In this design, the user has no rigid control over the saw to keep its reciprocating blade from jumping around uncontrollably, including out of the cut. Without having rigid control of the saw, especially at the moment that the branch is severed, this design lends itself to the saw falling out of the tree and breaking its blade or causing more serious damage to the saw, especially if it falls onto a hard surface, such as concrete. An even more serious risk to using such an uncontrolled device could be its falling out of the tree and striking a nearby person or pet.

The angled gripping device, which is installed on only one side of the saw described in this invention would work on only one side of the tree's trunk if there were obstructions, eg., a fence, wall or ditch on the far side of the tree's trunk. In such situations, if the user tried to use it to prune a branch on the opposite side of the tree's trunk (which could happen 50% of the time) this invention has no provision for hanging onto a branch's stub once the branch has been cut through.

A further drawback to the design of the saw described in this invention is that it has no provision for pruning a branch nearly flush with a tree's trunk, because its blade is positioned in the plane of the saw's longitudinal centerline, which could place the blade unacceptably far away from the trunk of the tree. Some pruning procedures require cutting the branch closer to the trunk of the tree than this saw will allow.

In order to be rigid enough to serve as an effective channel for the shoe of the saw to slide freely back and forth in, the base adapter described in this invention would need to be fashioned from a relatively heavy piece of material, which would add to the cumbersomeness of using this device because of the force moment resulting from having the added weight positioned at the distal end of a long handle. Close machining tolerances for that part would be necessary to prevent the saw's shoe from “cocking” inside its channel and machining it to such close tolerances would make it susceptible to getting clogged by sawdust and other debris. The number of parts and operational steps required to manufacture this device would render it prohibitively expensive to manufacture for the consumer environment.

Other inventions of the prior art that relate to the present invention have to do with supplying electrical power through a coiled electric cord installed inside the hollow extension handle of an electric powered cutting device. Two inventions embodying this concept are U.S. Pat. No.4,976,031 to Miller, dated Dec. 11, 1990 and U.S. Pat. No. 5,826,341 to Massa, dated Oct. 27, 1998. The drawback to this approach is that neither of these inventions has provisions for preventing the smaller, inner tube of the handle from being twisted inside the larger diameter, outer tube of the handle when the clamp securing the handles together is loosened. This can lead to the coiled wire inside the hollow handle becoming overly twisted and lead to entrapment of the cord and possible premature failure. A further drawback to such handles that I have examined is that they have no apparent provision for preventing the user from inadvertently pulling the handle sections completely apart during normal use.

Further, there are other powered extension handle equipped cutting devices that fall within the purview of the present jigsaw that have been considered. More particularity, electric powered shear type cutting devices, electric powered horizontal blade reciprocating saws, both gasoline and electric powered chain saws are all known to the prior art. The shear-type cutting devices are limited to the capability of cutting workpieces that have a relatively small cross-section. Chain saws and horizontal blade reciprocating saws are all relatively heavy in comparison to the present jigsaw. Because of this, they are more difficult and cumbersome to use when attached to the distal end of an extension handle because of the greater force moment that their weight creates at the end of the handle.

Jigsaw blades that have teeth on both their leading and trailing edges are also known in the prior art. None of those that I have researched have claimed this feature as a means of enabling the saw to be used for cutting while it is being both pushed into the workpiece being cut or being pulled into or across the workpiece being cut without having to remove the blade in order to reorient its teeth. It may be that such usage methodology was unobvious because a saw, such as the present saw, that can avail itself to the efficient use of a double-edged saw blade had not yet been designed.

Some inventions that disclose “double-Edged” saw blades for jigsaws are: U.S. Pat. No.448634 to Hickman, dated Oct. 02, 2001, which incorporates a fine pitch row of teeth on one edge of the blade and a course pitch row of teeth on the opposing edge of the blade. It was apparently invented to have one blade serve two cutting purposes. The blade would have to be removed and turned around when used in a conventional jigsaw, however, unless the user can contend with moving the jigsaw backwards over the workpiece and having the entire length of the body of the jigsaw obstruct backward movement of the jigsaw. Trying to use such a blade on a jigsaw that has a blade backstop would also be problematic. Another invention related to this subject is U.S. Pat. No. 5,517,889 to Logan, dated May 21, 1996. The claims of this invention are slanted towards its being a blade that can be used to start a cut without a pilot hole. Invention D427865 awarded to Mills, Jr., dated Jul. 11, 2000 is quite similar to the invention just mentioned and makes no claims concerning its utilitarian function.

### SUMMARY

In view of the foregoing disadvantages inherent in the types of powered devices using extension handles that I have cited from the prior art, my proposed jigsaw, which will be described subsequently in greater detail, is a new and improved jigsaw, which incorporates all of the advantages of the cited prior art and none of the disadvantages. My proposed jigsaw is a new and improved jigsaw that can be designed to incorporate extension handles of various fixed lengths or telescopically adjustable lengths. It can cut a workpiece to within less than one-half inch flush of a surface such as a wall or tree trunk that lies in an intersecting perpendicular plane and can be built with minimal modifications made to conventional, hand held electric jigsaws that are currently available. Three embodiments of this jigsaw are being presented in this disclosure: One is equipped with a telescoping extension handle; another is equipped with an extension handle of fixed length, a third uses batteries as a source of electrical power. Each embodiment uses a cutting blade that has a row of teeth on both the front and the rear edge of the blade. These embodiments are ideal for enabling a user to cut a workpiece, such as the branch of a tree, far beyond the user's normal reach. Additionally, because of the nature of its intended applications (certainly not close quarters due to the long handles), it can take advantage of the efficiencies to be gained from the use of the double-edged saw blades, as will be described in this application.

Accordingly, besides the objects and advantages of my new jigsaw, its various handles and other embodiments summarized above, several objects and advantages of the present invention are:

Objects and Advantages

(a) to provide an extension handle equipped, electrically powered jigsaw that can enable a user to perform cutting tasks at a distance far beyond his or her normal reach;

(b) to provide an extension handle equipped electrically powered jigsaw that cuts more efficiently than non-powered saws and can cut objects such as tree branches that are larger in diameter than those that can be cut by hand-held shearing type cutting devices;

(c) to provide an extension handle equipped electrically powered jigsaw that has handle sections that can not be twisted in relation to each other or pulled apart in relation to each other during normal use;

(d) to provide an extension handle equipped electrically powered jigsaw that is easy to understand and use;

(e) to provide an extension handle equipped electrically powered jigsaw that has a cutting blade with a row of teeth on both its front edge and its rear edge enabling the saw to cut while the blade is being pushed into the work that is being cut or pulled into the work when appropriate without the user having to remove the blade and reorient the pointing of its teeth;

(f) to provide an extension handle equipped electrically powered jigsaw that can also use readily available prior art saw blades and other constituent components;

(g) to provide an extension handle equipped electrically powered jigsaw that allows a user to select blades of a variety of pitches to satisfy task requirements;

(h) to provide an extension handle equipped electrically powered jigsaw that is capable of cutting a workpiece flush to within less than ½ inch of a raised perpendicular surface;

(i) to provide an extension handle equipped electrically powered jigsaw that allows its user to firmly and dilligently hold the saw in the desired position against the workpiece while cutting it;

(j) to provide an extension handle equipped electrically powered jigsaw that can be easily built, with minimal development and manufacturing costs, by a manufacturer that currently makes conventional hand-held jigsaws;

(k) to provide an extension handle equipped electrically powered jigsaw that a manufacturer can market to its existing distribution channels with minimal training of its existing sales force;

(l) to provide an extension handle equipped electrically powered jigsaw for manufacturers desiring to enter that market but are precluded from doing so because of their inaccessability to patents or trade secrets on powered cutting devices with extension handles of the prior art held by others;

(m) to provide an extension handle equipped electrically powered jigsaw that is relatively light weight;

(n) to provide an extension handle equipped electrically powered jigsaw that has a handle that is electrically insulated from the user;

(o) to provide an extension handle equipped electrically powered jigsaw that incorporates a “normally off” “dead man's” switch as a safety measure.

Further objects and advantages will become apparent from a consideration of the ensuing drawings and detailed descriptions of the embodiments of this new extension handle equipped electrically powered jigsaw.

### DRAWINGS

FIG. 1 is a left side view of a typical conventional hand-held jigsaw from which the present saw was made.

FIG. 2 is a front view of the jigsaw described in FIG. 1 with its shoe and bevel guide removed to provide for installing a new shoe and other modifications.

FIG. 3 is a front partial view of a new blade actuator for the present saw.

FIG. 4 is a bottom view of a new blade actuator for the present saw.

FIG. 5 is a top view of a universal blade clamp for the present saw.

FIG. 6 is an exaggerated view of a dual-edge cutting blade for the present saw.

FIG. 7 is the bottom view of a new shoe for the present saw.

FIG. 8 is a left side view of the present saw without an extension handle attached and with a single-edged saw blade installed.

FIG. 9 is the front view of the present saw with a single-edged blade installed on the left side.

FIG. 10 is a left side view of the present saw with a double-edged blade installed.

FIG. 11 is a view of the lower portion of the inner handle tube assembly of the present saw.

FIG. 12 is a cross sectional view of the inner handle tube assembly taken along line 12-12 of FIG. 11.

FIG. 13 is a view of the front end of a compression sleeve for securing the hexagonal shaped inner handle tube to the round outer handle tube of the present saw.

FIG. 14 is a view of the round outer handle tube of the present saw with the compression sleeve attached to its upper end.

FIG. 15 is a view of the inner handle tube assembly inserted into the outer handle tube and through the compression sleeve.

FIG. 16 shows the handle power cord and the handle power switch installed on the new telescoping handle assembly of the preferred embodiment of the present saw.

FIG. 17 is a fragmentary cross-sectional view of the mated handle sections of the present saw showing a coiled electric cord.

FIG. 18 shows the new saw shoe attached to the inner handle tube of the preferred embodiment of the present saw.

FIG. 19 is a left side view of the preferred embodiment of the present saw with the telescoping handle assembly attached and a double-edged blade installed.

FIG. 20 is a new shoe mounting spindle for the 1st alternative embodiment of the present saw.

FIG. 21 is a view of the top portion of a new, non-telescoping handle for the 1st alternative embodiment of the present saw.

FIG. 22 is a side view of the 1st alternative embodiment of the present saw.

FIG. 23 is a view of the lower part of the handle tube where batteries may be installed.

FIG. 24 is a view of a battery compartment attached to the lower part of the handle tube.

Reference Numerals in Drawings (* Denotes Prior Art)

| | | | |
|---|---|---|---|
| 12 | Cross Sectional View Of Inner Handle Tube Assembly | | |
| 17 | Fragmentary Sectional View Of Telescoping Handle Sections | | |
| 30 | Side View Of Prior Art Saw Assy.* | 32 | Saw Power Switch* |
| 34 | Saw Power Cord* | 36 | Blade Actuator* |
| 38 | Blade Clamp* | 40 | Saw Body* |
| 42 | Blade Clamp Screw* | 44 | Single-Edge Blade* |
| 46 | Shoe* | 48 | Bevel Guide* |
| 50 | Front View Of Prior Art Saw Assy.* | 52 | New Blade Actuator |
| 54 | Threaded Mounting Holes (2) | 56 | Blade Actuator Grooves (2) |
| 58 | Blade Clamp Grooves (2) | 60 | New Blade Clamp |
| 62 | Smooth Mounting Holes (2) | 64 | New Shoe |
| 66 | Blade Slots (2) | 68 | Countersunk Mounting Holes (2) |
| 70 | Side View Of Present Saw | 72 | New Clamp Mounting Screws (2) |
| 74 | Front View Of Present Saw | 76 | Inner Handle Tube Assy. |
| 78 | Inner Handle Tube | 80 | Positioning Ring |
| 82 | Compression Sleeve | 84 | Compression Lobes (6) |
| 86 | Outer Handle Tube | 88 | Handle Power Switch |
| 90 | Handle Power Cord | 92 | Shoe Spindle |
| 94 | Spindle Mounting Screws (2) | 96 | Coiled Electric Cord |
| 98 | Grommet | 100 | Handle Stop |
| 102 | Compression Ring | 104 | Line Plug |
| 106 | Extension Handle (Alt. Embodiment) | 108 | Spindle (Alt. Embodiment) |
| 110 | Spindle Slot | 112 | Spindle Mounting Holes (2) |
| 114 | Handle Mounting Holes (2) | 116 | Spindle Mounting Screws (2) |
| 118 | Telescopic Handle Assembly | 120 | Double-Edge Blade |
| 122 | Handle End Plug | 124 | Battery Handle End Plug |
| 126 | Batteries (# Varies) | 128 | Battery Compartment |
| 130 | Handle For Internal Batteries | 132 | Handle For External Batteries |

### DESCRIPTIONS OF THE PREFERRED EMBODIMENT

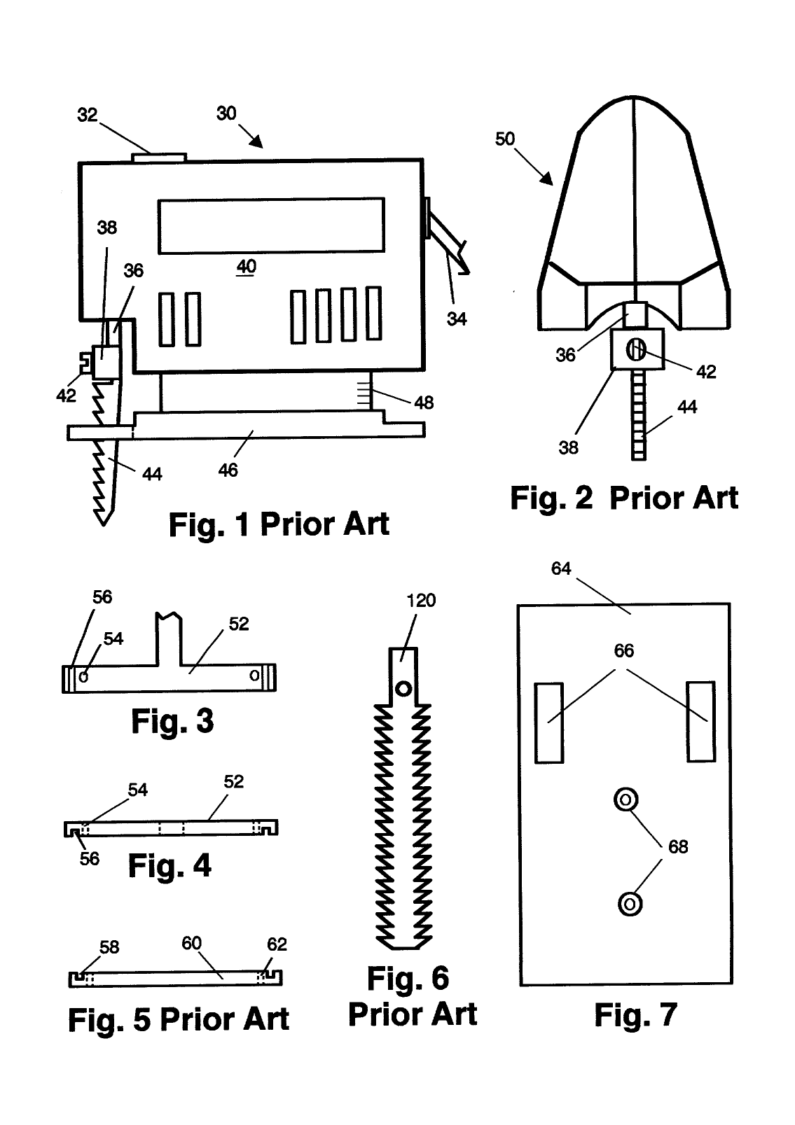

Description—FIG. 1

Ref. 30 is a side view of a conventional hand-held jigsaw from which the present jigsaw has been constructed. This view resembles a Black & Decker (TM) Model 7548, which can be easily modified into the present jigsaw. Another saw that can be used to effect the design of the present saw is the Handi Works (TM) Model HW5552 Type 1 made in England, which would also require a minor modification to its housing, which I have already done and tested. Ref. 40 is a body for the saw. The saw is turned either on or off by a saw power switch 32, which derives power through a saw power cord 34. Turning the saw on causes a shaft-like blade actuator 36 to vertically reciprocate an attached saw blade 44 in a linear fashion to effect the cutting action. The saw blade 44 is attached to the blade actuator 36 by a blade clamp 38 using a clamp screw 42. A bevel guide 48 is attached to a saw shoe 46 and, conjunctionally, they provide stability for the saw while it is cutting, as well as determine the angle of cut.

Description—FIG. 2

Ref. 50 shows a front view of a conventional hand-held jigsaw. Its shoe 46 and bevel guide 48, shown in FIG. 1, have been removed to enable modifying the saw. All other reference numerals in this view were described in FIG. 1.

Description—FIG. 3

Although not limited to that task, the present extension handle equipped jigsaw is ideal for serving as a tree pruning device, so its description will be slanted accordingly. In order to modify a conventional hand-held jigsaw so that it can cut a workpiece, such as a branch or limb, nearly flush with the trunk of a tree, it was necessary to modify the blade actuator 36 of the prior art saw shown in FIG. 1. FIG. 3 shows a front view of the lower portion of a new blade actuator 52 that will replace the blade actuator 36 of the prior art saw. This figure shows the inverted “T” design of the new blade actuator 52, as well as blade actuator grooves 56 (one on each end) that will ensure accurate positioning of the saw blade 44. When the blade 44 is attached to either of the far ends of the crossmember of the inverted “T”, they are capable of cutting a workpiece such as a tree limb or branch nearly flush with a raised perpendicular intersecting obstruction, such as the trunk of a tree. The function of two threaded mounting holes 54 will be described in FIG. 5.

Description—FIG. 4

FIG. 4 is a bottom view of the new blade actuator 52. Each of the reference numerals in this figure has been described in FIG. 3.

Description—FIG. 5

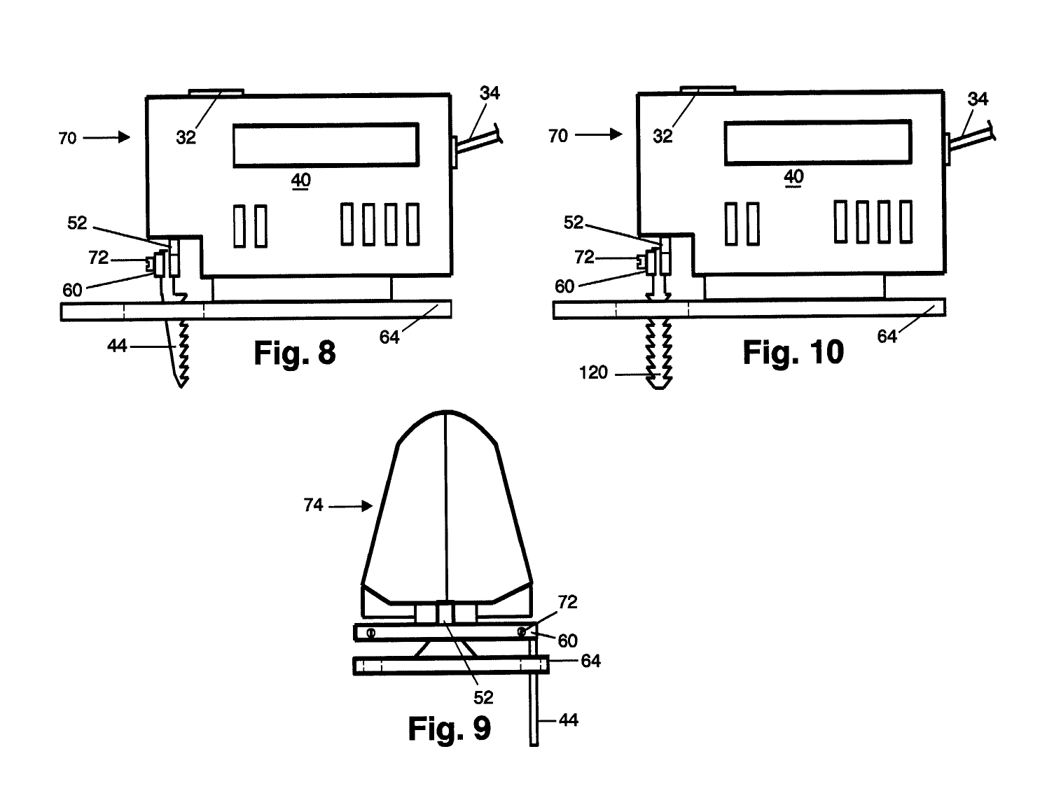

Ref. 60 is a new universal blade clamp that will be used to secure the blade 44 to the blade actuator 52. The clamp 60, which was first described by me in another patent application Ser. No. 10/005,630, that I filed on Dec. 5, 2001, is universal in the sense that it can be used to attach the blade 44 to either side of the saw without the user having to completely remove the clamp 60. Blade clamp grooves 58 are positioned to align the blade 44 with the blade actuator grooves 56 in the blade actuator 52 shown in FIG. 4. Machine screws 72, which will be shown in FIG. 8 will be inserted through smooth mounting holes 62 and used to secure the clamp 60 onto the blade actuator 52 into threaded holes 54 of that part.

Description—FIG. 6

FIG. 6 is a magnified side view of a new double cutting-edge blade 120 for the present saw. Having rows of teeth on both the leading edge and the trailing edge of this blade enables a user to cut with it while pulling the saw down onto a workpiece or up into the workpiece. This precludes the necessity for the user having to stop work in order to remove the blade and reorient the pointing of its teeth. I believe this to be a novel application for this dual-edged blade that was apparently nonobvious in earlier patent applications, such as U.S. Pat. No. 4,566,188.

Description—FIG. 7

FIG. 7 shows the bottom view of a new shoe 64 for the present saw. Its countersunk mounting holes 68 are positioned so that the shoe 64 can be attached directly onto the base of the body 40 of the prior art saw once the former shoe 46 and the former bevel guide 48 have been removed as described in FIG. 2. Wide slots 66 enable either the blade 44 or the blade 120 to operate freely within the confines of the shoe 64 regardless of which side of the new saw's blade actuator 52 the blades are installed on. The dimensions and positioning of these slots also permit installation of the blade 44 with its teeth pointing towards either the front or the rear of the saw. The narrow strip of material surrounding the outer sides of the slots 66 guard the reciprocating blade actuator 52 and the side of the blades 44 or 120 from contacting the rough bark of the trunk of the tree, thus interfering with the cutting action. This design enables the saw to cut very close to a surface, such as the trunk of a tree, occupying an intersecting perpendicular plane.

Description—FIG. 8

Ref. 70 is a left side view of the present jigsaw without the extension handle, described in later figures, yet installed onto it. In this figure, the single-edge blade 44 is installed with its teeth pointing towards the rear of the saw, which is usually ideal for cutting down into an overhead workpiece. This view shows how machine screws 72, first mentioned in FIG. 5, are used to mount the clamp 60 that will secure the blade. The reason why I am showing single-edge blades in this application is because, although patents on double-edge designs have been issued, eg., U.S. Pat. No. 448,634, I haven't actually seen such a blade on the market and don't know why, since I have already pointed out in FIG. 6 a usage methodology that makes such a design viable. All of the other reference numerals shown in this view have been described in earlier figures.

Description—FIG. 9

Ref. 74 is a view of the front of the present jigsaw with the single-edge blade 44 attached to the left side of the blade actuator 52. This figure shows a clearer view of how the blade clamp 60, installed with machine screws 72, spans the breadth of the inverted “T” lower portion of the blade actuator 52 to secure the blade 44. All other reference numerals in this view have been described in previous figures.

Description—FIG. 10

FIG. 10 is a left side view of the present jigsaw with the double-edge saw blade 120 installed on it. Ref. 70 is still used to show this view, since it still generally refers to the saw and the only change has been to the type of blade. All other reference numerals in this view have been described in previous figures.

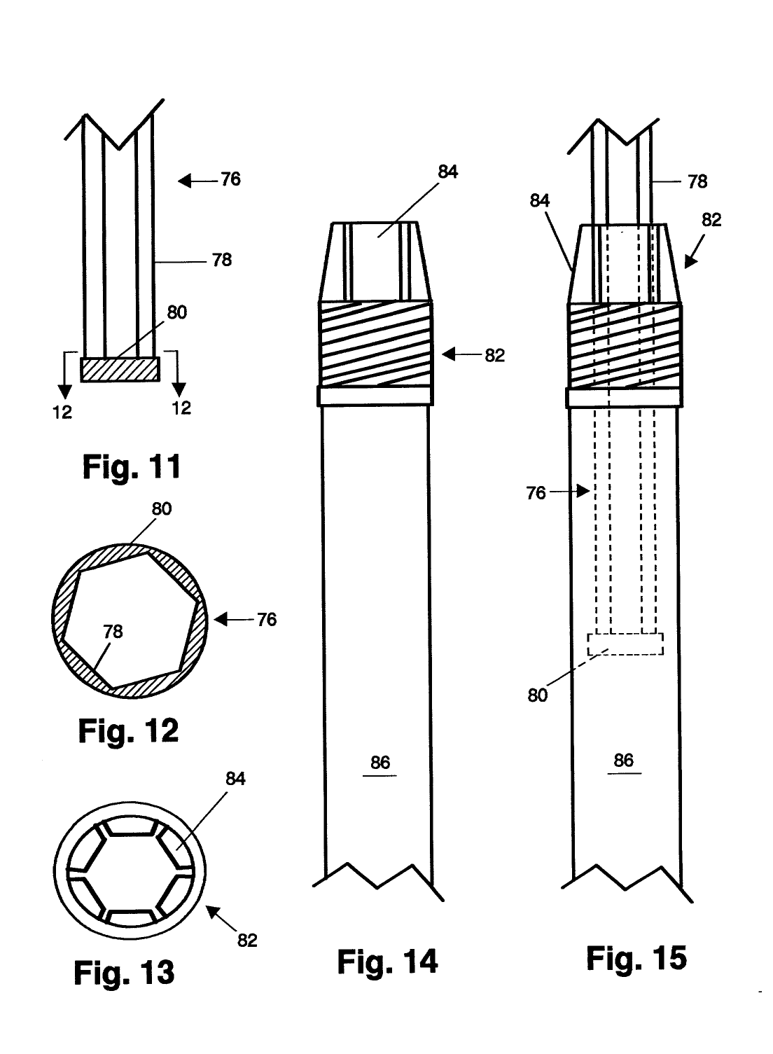

Description—FIGS. 11 thru 15

Two drawbacks to using a round extension handle section slid into a larger diameter round outer extension handle section are that the handle sections can be twisted in relation to each other and that there are no disclosed provisions for preventing the two handle sections from being pulled completely apart during normal use. This is an undesirable consequence as far as the design of the present jigsaw is concerned. FIGS. 11 thru 15 attempt to address those limitations. Ref. 76 is an inner handle tube assembly consisting of a hexagonal shaped inner handle tube 78 that is fitted with a circular positioning ring 80 (hashed for clarity) firmly attached its lower end. The outside diameter of the positioning ring 80 is slightly larger than the distance across the two farthest apices of the hexagonal shaped inner handle tube 78. The broken lines with arrows labeled 12 refer to FIG. 12. Referring to FIG. 12, the ring 80 has a hexagonal shaped hole concentric with its outer diameter and is dimensioned so that the ring 80 will fit snugly onto the tube 78 and is then firmly affixed to it (possibly by using an adhesive). The significance of this design will be further described in FIGS. 12 thru 15. Although a hexagonal shaped tube has been described in this specification and shown in the drawings, it is to be understood that tubes in other polygonal shapes, such as octogons, pentagons, squares, etc., may also be used. The fewer the number of sides that the inner handle tube 78 has, the larger its cross section will need to be in order to accommodate a coiled cord 96 that will be mentioned in FIG. 17, so my choice of a hexagonal tube was a compromise. Even circular tubing with a keyway could be used as well to prevent the twisting effect. This fact is probably obvious to an examiner of this application skilled in the art, but I will attempt to address that issue in the wording of the “claims”.

FIG. 12 is an enlarged cross sectional view of the bottom of the inner handle tube assembly 76 taken along line 12-12 of FIG. 11. The hatched area (for clarity) shows the material comprising the positioning ring 80. FIG. 13 is the top end view of a compression sleeve 82 which, although a one-piece, molded part in actual practice, has been referenced by an arrow to clearly deleneate its six flat-faced compression lobes 84. These lobes will be used to press against the flat sides of the hexagonal inner handle tube 78 described in FIG. 11. The shaded area of the positioning ring 80 (FIG. 12) shows the amount of its material that exceeds the maximum width of the hexagonal inner handle tube 78 and, therefore, exceeds the size of the hexagonal hole shown in the compression sleeve 82 (FIG. 13) that the inner handle tube 78 will slide through. This shaded area also shows material that will prevent the turns of a coiled electric cord (labeled 96 in FIG. 17) from being entrapped or pinched between a flat side of the hexagonal tube 78 and the open arc formed by the inside diameter of the round outer handle section 86 (shown in FIG. 14) and a flat side of the inner handle tube 78 (FIG. 12). Once the inner handle tube 78 is slid through the compression sleeve 82 until the positioning ring 80 is brought into contact with the lobes 84 of the compression sleeve 82 it is stopped. This prevents the user from inadvertently pulling the two handle tubes apart during normal use, as will be further described in FIG. 15.

FIG. 14 shows a side view of the compression sleeve 82 firmly attached to the upper end of an outer handle tube 86, which is a cylinderical tube made from a strong, lightweight, electrically nonconductive material. Those skilled in the art will appreciate the function of the sleeve's coarse external threading and the compression lobes 84 shown in this view.

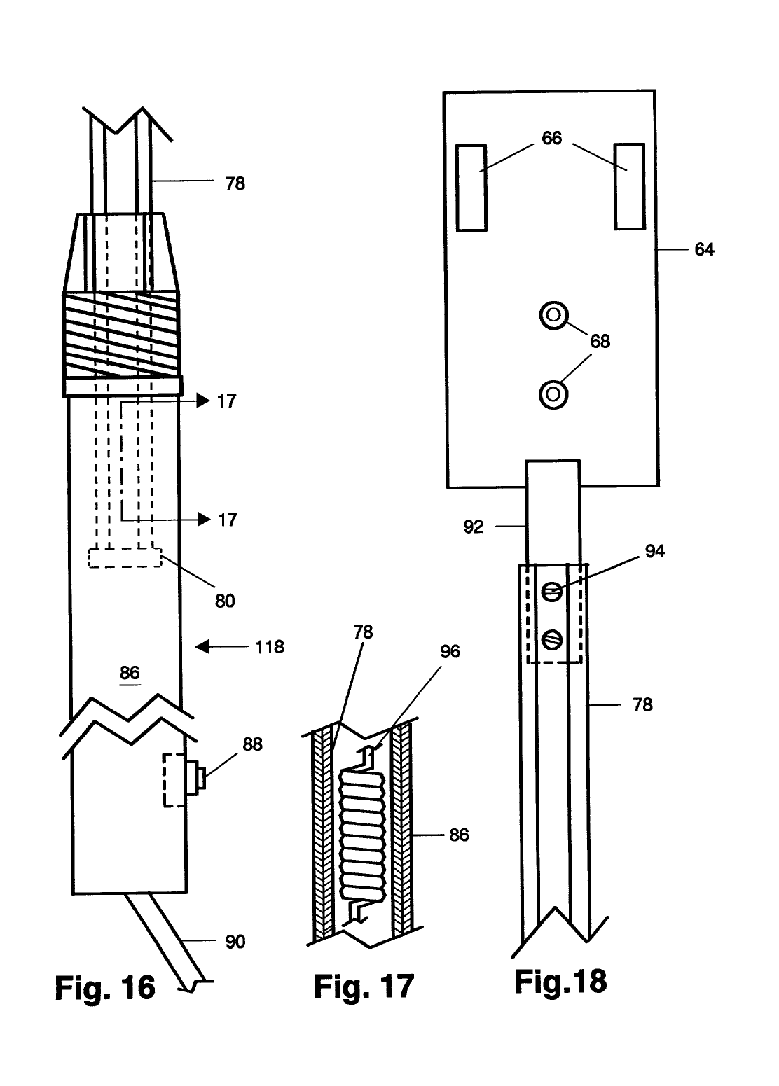

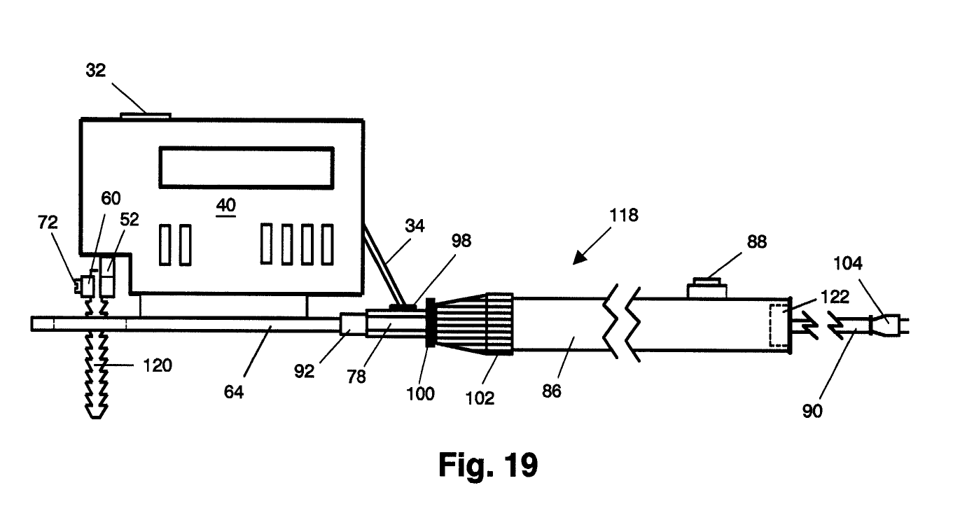

FIG. 15 shows the inner handle tube assembly 76 inserted into the outer handle tube 86 and through the compression sleeve 82. The diameter of the positioning ring 80 is dimensioned so that it has a “sliding” fit into the outer handle tube 86. Since the inside faces of the lobes 84 of the compression sleeve 82 are flat and coincide with the flat surfaces of the inner handle tube 78, they are positioned to be tightened by a compression ring 102, shown later in FIG. 19, to prevent twisting of the inner handle tube 78 in relation to the outer handle tube 86 under normal use. It is this inability of the user to twist the two handle sections in relation to one another that will minimize the chances of the user inadvertently overly twisting the electrical wiring that will run through this hollow handle as will be pointed out in FIG. 16. This figure provides a better view of what happens when a user attempts to pull the two handle sections apart: When the inner handle tube assembly 76 is slid upwardly inside the outer handle tube 86, its travel is stopped once the positioning ring 80 contacts the lobes 84 of the compression sleeve 82, since the sleeve 82 is rigidly attached to the top end of the outer handle tube 86.

Description—FIG. 16

In the interest of clarity, this view excludes references to some of the embodiments already shown and described in earlier figures of this application. FIG. 16 shows the telescoping extension handle assembly 118 assembled and a “dead man” handle power switch 88 installed to switch the power from the handle power cord 90. A coiled electric cord 96, (shown in FIG. 17) is used to conduct the electricity from the output side of the switch 88 through the hollow handle tubes 86 and 78 and ultimately to the saw, which will be mounted on the distal end of the handle assembly 118 as will be shown later in FIG. 19. Constant tension is applied to the coiled cord 96, so that it is stretched by some amount in both the fully extended state and the fully contracted state. This will minimize the chances of the coiled cord 96 jamming inside the hollow handle assembly 118.

Description—FIG. 17

FIG. 17 is a fragmentary cross-sectional view of the new telescoping handle assembly 118 taken along line 17-17 of FIG. 16. The coiled electrical cord 96 used in my prototype is 11/16 inches in diameter in the fully contracted state and extends at a ratio of roughly 10:1. Its 20 AWG conductors can more than adequately handle the current requirements (2.2-3.0 amps) of typical lightweight jigsaws. The small diameter of the coil in its fully contracted state allows a manufacturer to build relatively small cross-section handles that are lightweight and easy to use. The two tubular handle sections, 78 and 86 were described in earlier figures. Although other materials may be used, my prototype uses aluminum for the inner handle tube 78 and fiberglass for the outer handle tube 86. The coiled power cord 96 was obtained from Meyer Wire & Cable Company, Hamden, Conn. Consult the Thomas Register (TM) at WWW.THOMASREGISTER.COM for sources of aluminum or fiberglass tubing. I suggest using a 1½ inch diameter outer handle tube 86, then calculating the cross section dimensions of the hexagonal inner handle tube 78. One source for that tube is Precision Tube Company, phone 1-800-889-5878.

Description—FIG. 18

FIG. 18 discloses a provision for attaching the preferred embodiment of the present saw to the inner handle tube 78 and consequently to the extension handle assembly 118. The new shoe 64 is welded into a slot (not shown) in the end of a new shoe mounting spindle 92, which is inserted and secured into the upper end of the inner handle tube 78. Although screws 94 are shown as the method of attachment, other secure attachment methods, such as adhesive bonding may be used. This apparatus is attached to the bottom of the saw using countersunk screws (not shown) into the base of the saw's housing 40 through the mounting holes 68 of the shoe 64.

Description—FIG. 19

FIG. 19 is a left side view of the preferred embodiment of the present saw, electrically hooked up and attached to its telescoping extension handle assembly 118. The line plug 104 feeds household electric current through the handle power cord 90 which is routed through the handle end plug 122 and is connected through the normally off handle switch 88 and then routed through the hollow handle assembly 118 to where it is electrically connected to the coiled power cord 96 shown in FIG. 17. The coiled cord 96 is electrically connected to the saw power cord 34, which is electrically insulated from the inner handle tube 78 by a grommet 98. A stop ring 100 is fixed onto the inner handle tube 78 to prevent the tube 78 from being pushed too far into the outer handle tube 86, thus causing possible damage to some of the parts inside the tube assembly 118. The threaded compression ring 102 (first mentioned in FIG. 15) may be loosened or tightened to apply or relax pressure on the compression lobes 84 of the compression sleeve 82 (FIG. 15) to enable adjusting the length of the telescopic handle assembly 118. All other reference numerals in this figure have been previously described in earlier figures.

Operation of the Preferred Embodiment

The new blade actuator 52 is designed for installing the blade 120 on either the left side or the right side of the saw using the universal blade clamp 60. The blade is installed by loosening, but not removing, both clamp mounting screws 72, inserting the blade 120 into the desired positioning grooves, 56 and 58 (FIGS. 4 & 5), then firmly tightening both screws 72. Many users will find that installing the blade on just one side of the saw (whichever side they are most comfortable with) will suffice for their requirements. If they can manuever all the way around the object, such as a tree, for example, they can install the blade on either side of the saw and be able to prune branches nearly flush with the trunk of the tree. If they are obstructed (eg., by a house, fence or ditch) from moving all around the tree, however, it may be necessary for them to relocate the blade to the opposite side of the saw in order to make nearly flush cuts on certain sides of the tree's trunk.

If the prior art jigsaw from which this present jigsaw is made has provisions for locking the switch 32 on its body in the “On” position, that should be done. The telescoping handle tubes 78 and 86 should be adjusted for the desired handle length and secured in place by tightening the compression ring 102. The handle assembly 118 should then be used to raise the saw up to the target branch and the forward end of its shoe 64 allowed to rest on the branch near the point where the cut is to be made, but without the forward row of teeth of the saw blade 120 in contact with the branch. Turn the saw on by applying continuous pressure to the switch 88, which will shut off if pressure is released from it for any reason. With the saw now running, the user can push up on it so that the forward teeth of its blade 120 come into contact with the branch and make a shallow cut into it on its lower side. The user then removes the saw from that cut and raises the saw so that its lower blade teeth are above the branch to be cut and in line with the first cut that was made. The user then uses the saw to cut down on the branch until it is severed.

If the user chooses to use a less preferred blade with a single row of teeth, such as blade 44 shown in FIG. 8, he or she would need to install the blade so that its teeth are pointing forward to make the initial cut underneath the branch, then remove the blade and orient it so that its teeth are pointing towards the rear of the saw's body 40 to make the final cut down through the top of the branch. Those knowledgeable of proper pruning techniques will understand and appreciate the above procedures.

Description of the 1st Alternative Embodiment

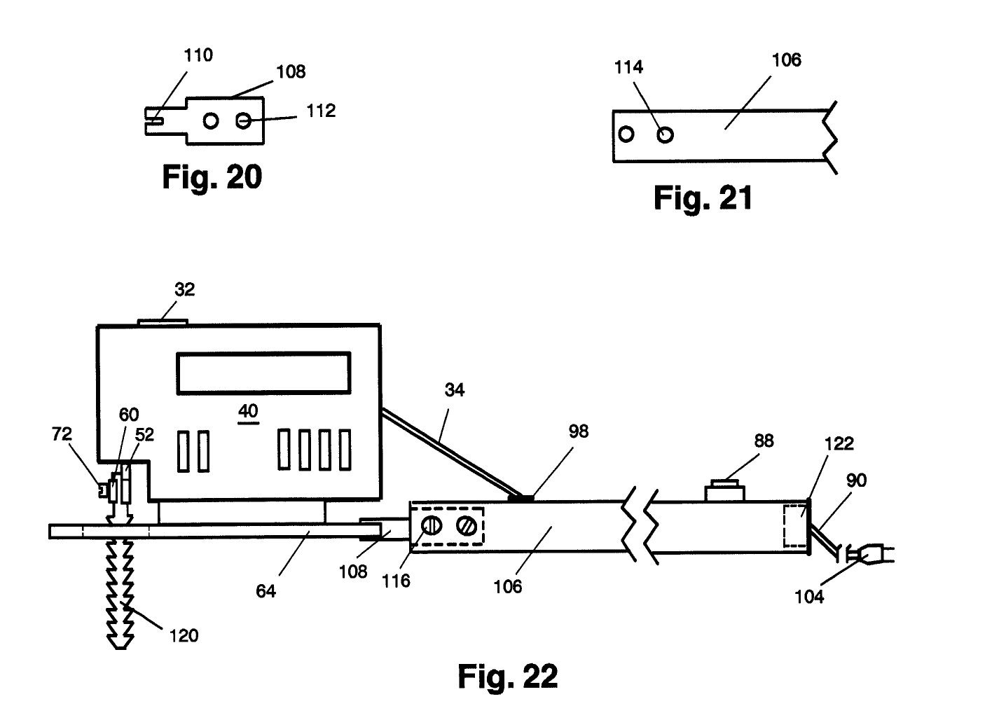

The 1st alternative embodiment of this invention would yield a less costly product which would have an extension handle of a fixed length, rather than one that telescopes. The manufacturer would determine how long that handle should be based on consumer demand. I envision a manufacturer making two or three different handle lengths to satisfy a variety of user needs. FIGS. 20, 21 and 22 describe changes to the aforedescribed preferred embodiment that would be incorporated into the design of the 1st alternative embodiment. A new shoe mounting spindle 108 has a large cross section end that will fit snugly into the hollow end of a new handle tube 106 made of a durable, electrically nonconductive tubing material. The spindle 108 is inserted into and secured to the handle 106 either by fastening with screws 116 placed through mounting holes 112 and 114 or adhesive bonding. The small cross section end of the spindle 108 has a slot 110 in it that allows it to be durably welded to the saw shoe 64. The saw power cord 34 is routed through the grommet 98 into the handle 106 where it is connected to the switch 88 which is fed by the handle power cord 90 fitted with the plug 104.

Operation of the 1st Alternative Embodiment

The operation of this embodiment is identical to that of the preferred embodiment with the exception that the length of the handle is not adjustable.

Description of the 2nd Alternative Embodiment

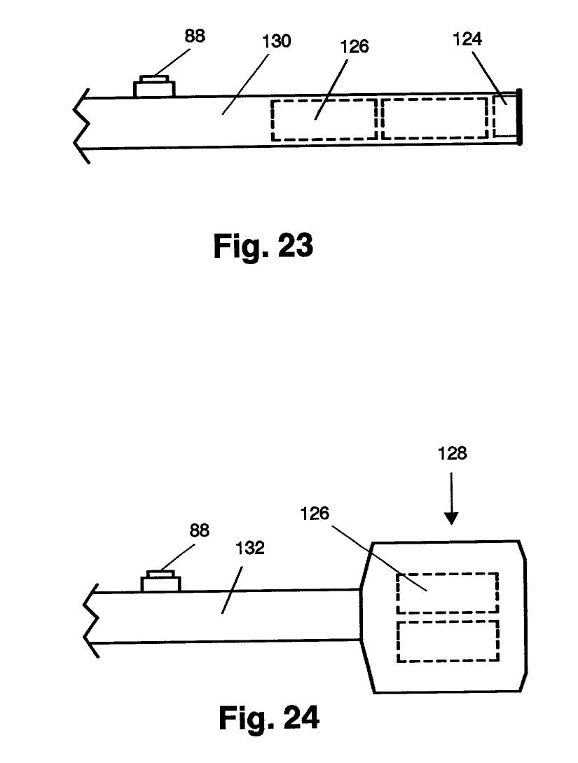

The 2nd alternative embodiment of this invention uses batteries as a source of electrical power. FIG. 23 schematically shows batteries 126 inserted into a compartment (not shown) within a lower handle 130, which has purposefully been assigned a new reference number due to its internal construction. An end plug 124 may be of the screw-in type or the quick-disconnect type. FIG. 24 shows the batteries 126 contained within a compartment 128 rigidly affixed to the end of an appropriate handle 132.

Should batteries be used as a source of electrical power, the handle power cord 90 and the line plug 104 would be deleted from the design of the present saw, and the motor of the jigsaw 70 shown in FIG. 8 would be selected to satisfy the appropriate electrical power requirements.

Operation of the 2nd Alternative Embodiment

Operating the battery powered version of the present saw is otherwise unchanged except for the lack of a need to deal with external electrical connections. Although not essential, I recommend the use of rechargeable batteries for this application.

Conclusion

Accordingly, the reviewer will see that there are significant advantages of the proposed extension handle equipped electrically powered jigsaw over devices using either manual sawing or shearing, powered chain saws or other forms of powered reciprocating saws. The use of a jigsaw as the cutting component of the present saw provides a lightweight cutting device that can, consequently, be raised to greater heights than heavier cutting devices. The present jigsaw can also cut through a workpiece that has a greater cross section than a hand-held shear type pruner can cut through. The use of blades with relatively finely spaced teeth enables the user of the present jigsaw to experience significantly less “jerking” and “kickback” when cutting through a workpiece compared to when using chainsaw type cutting devices. The present jigsaw uses handles that are electrically insulated from the user as a safety consideration.

Development, manufacturing and distribution costs are also important, because of the impact that they ultimately have on the price of a product to the consumer. Those costs have been minimized in designing the present jigsaw by modifying an existing saw design that has already been developed and tested. In addition, the present jigsaw can be built and distributed by manufacturers of conventional hand-held jigsaws, that already have the sales force and distribution channel established.

Thus, it will be understood that while the form of the invention herein shown and described constitute preferred embodiments of the invention, it is not intended to illustrate all possible forms of the invention. It will also be understood that the words used throughout this application are words of description rather than words of limitation and that various changes may be made without departing from the spirit and scope of the invention herein disclosed and claimed.

What is claimed is:

1. An extension handle equipped electrically powered jigsaw comprising:
an elongated tubular handle, with a power cord routed through it, that enables a user of said jigsaw to perform cuts on a workpiece that is far removed from the user's normal reach;
an elongated tubular inner handle, with a power cord routed through it, telescopically mounted within a larger cross-section outer tubular handle that enables a user of said jigsaw to perform cuts on a workpiece that is far removed from the user's normal reach;
adjustment and locking means for varying the positioning of said tubular handles inwardly and outwardly with respect to each and locking said handles in selected relation to each;
restricting means for preventing said inner and outer tubular handles from being twisted or separated in relation to each;
less mass and consequently less weight than conventional chainsaw and horizontal reciprocating blade type cutting devices;
an electric motor contained within a housing;
said electric motor may be designed to use either household electric current or batteries as a source of power;
a means for converting the rotary motion of said electric motor to linear reciprocating motion at an attached blade actuator, which reciprocates in a plane perpendicular to the longitudinal centerline of the saw's housing;
an electrical cord extending from said electric motor through said tubular handles to a user accessible electrical on/off switch electrically connected to an appropriate source of either internally provided or externally sourced electrical power.

2. An electrically powered jigsaw capable of cutting a workpiece nearly flush with a raised perpendicular surface comprising;
a means enabling the blade of said jigsaw to be operably attached to either side of said jigsaw;
a means enabling the installation of a conventional jigsaw blade on said jigsaw with its teeth oriented towards either the front or the rear of said jigsaw;
a shoe that prevents the reciprocating components of said jigsaw from making contact with a raised surface perpendicular to the workpiece being cut;
a means that enable said jigsaw to cut a workpiece to within less than ½ inch of a raised surface perpendicular to the workpiece being cut;
a means for cutting a workpiece that is thicker than can be cut using hand-held shearing type cutting devices.

3. A jigsaw blade comprising a plurality of teeth on both its leading edge and its trailing edge;
said jigsaw blade may be designed in a variety of pitches to satisfy a variety of cutting needs, eg., 10 TPI for fine cuts, vs. 6 TPI for coarse cuts;
said jigsaw blade providing means for a user to cut a workpiece by either pushing the saw in which it is installed into the workpiece or pulling said saw down or across the workpiece without the need to remove and install the blade to orient the direction of its teeth;
said jigsaw blade, because of the finer pitch of its teeth, is capable of cutting a workpiece with less jerking and “kick-back” than would be experienced when cutting with a device equipped with coarser pitched chainsaw blades.
